(19) United States
(12) Patent Application Publication
(10) Pub. No.: US 2011/0147546 A1
(43) Pub. Date: Jun. 23, 2011

(54) Adjustable Display Arm

(75) Inventors: Fabian A. Monsalve, Brooklyn, NY (US); Kim ten Hacken, Scarborough (AU); Manuel Saez, Brooklyn, NY (US)

(73) Assignee: HUMANSCALE CORPORATION, New York, NY (US)

(21) Appl. No.: 12/646,506

(22) Filed: Dec. 23, 2009

(51) Int. Cl. F16M 11/06; F16M 13/00

(52) U.S. Cl. 248/122.1; 248/201

(57) ABSTRACT

An adjustable display arm utilizing a single motion, friction-locking hinge mechanism to allow a user to adjust the display height across a range sufficient to accommodate different-sized users while supporting the weight of an attached flat-panel display. The adjustable display arm can comprise a base assembly, an arm assembly, and a mount assembly. The arm assembly can have a lower arm bracket, an upper link, a hinge mechanism connecting the upper link's first end to the lower arm bracket, and an upper arm bracket attached to the upper link's second end. The hinge mechanism can have a shaft, a clutch bearing, and a friction pack. When assembled, the arm assembly's hinge mechanism will provide minimal resistance to a user raising an attached flat-panel display. However, the hinge mechanism's friction pack will provide resistance to the lowering of the arm assembly, thereby supporting the weight of an attached flat-panel display and effectively locking the adjustable display arm in the desired position.

### I. BACKGROUND

The present invention relates to mounting systems for flat panel displays. Recently, there has been a marked growth in the popularity of flat panel displays such as a flat screen computer monitors or flat screen televisions. It is becoming common to have flat panel displays attached to a work area with a display arm. These display arms may be non-movable providing only a single viewing position. In such situations, vertical adjustment of the display requires detaching the display arm and physically raising or lowering the point of attachment to the work area. In other embodiments, display arms may be hinged providing for vertical movement of the attached display. A locking mechanism will typically be utilized to fix the display arm at the desired position.

Current-generation hinged display arms typically utilize a gas cylinder to support the weight of the monitor and fix the display arm at the desired position. In addition to being bulky, the gas cylinders are failure-prone. Accordingly, it would be advantageous to have a durable mechanism for fixing a hinged display arm at the desired position, while still allowing easy adjustment of the vertical position of an attached flat panel display. Such mechanism should be capable of being mounted directly to a work station, and should allow a user to effortlessly adjust the display height across a range sufficient to accommodate different-sized users.

### II. SUMMARY

The invention disclosed herein is generally directed to an adjustable display arm for mounting a flat panel monitor or flat panel display. The adjustable display arm utilizes a single motion, friction-locking hinge mechanism which allows a user to adjust the height of the display screen to enable a comfortable, sustainable working posture. The display arm's hinge mechanism will provide minimal resistance to a user raising an attached flat-panel display. However, the hinge mechanism will provide resistance to the lowering of the arm assembly, thereby supporting the weight of an attached flat-panel display and effectively locking the adjustable display arm in the desired position.

An adjustable display arm having features of the present invention comprises an arm assembly having a lower arm bracket, an upper link, a hinge mechanism connecting the upper link's first end to the lower arm bracket, and an upper arm bracket attached to the upper link's second end. The hinge mechanism can have a shaft, a clutch bearing, and a friction pack. The shaft has a first end and a second end. The clutch bearing has an inner periphery and an outer periphery, with the inner periphery mounted to the shaft and the outer periphery mounted within the aperture in the lower arm bracket. The friction pack can comprise a hinge cap and a threaded fastener. The hinge cap can be attached to the shaft's first end such that the hinge cap rotates as the shaft rotates. The threaded fastener can extend through the hinge cap to engage a threaded bore in the shaft.

Another embodiment of an adjustable display arm having features of the present invention comprises an arm assembly having a lower arm bracket, an upper link, a hinge mechanism connecting the upper link's first end to the lower arm bracket, and an upper arm bracket attached to the upper link's second end. The hinge mechanism can have a shaft, a clutch bearing, and a friction pack. The shaft has a first end and a second end. The clutch bearing has an inner periphery and an outer periphery, with the inner periphery mounted to the shaft and the outer periphery mounted within the aperture in the lower arm bracket. The friction pack comprises a first hinge cap, a second hinge cap, and a threaded fastener. The first hinge cap is attached to the shaft's first end, while the second hinge cap is attached to shaft's second end. The threaded fastener extends through the second hinge cap and the shaft to engage a threaded bore in the first hinge cap.

Another embodiment of an adjustable display arm having features of the present invention comprises a base assembly, and arm assembly, and a mount assembly. The arm assembly has a lower arm bracket, an upper link, a hinge mechanism connecting the upper link's first end to the lower arm bracket, and an upper arm bracket attached to the upper link's second end. The hinge mechanism can have a shaft, a clutch bearing, and a friction pack. The shaft has a first end and a second end. The clutch bearing has an inner periphery and an outer periphery, with the inner periphery mounted to the shaft and the outer periphery mounted within the aperture in the lower arm bracket. The friction pack comprises a first hinge cap, a second hinge cap, and a threaded fastener. The first hinge cap is attached to the shaft's first end, while the second hinge cap is attached to shaft's second end. The threaded fastener extends through the second hinge cap and the shaft to engage a threaded bore in the first hinge cap.

The above summary is not intended to describe each illustrated embodiment or every possible implementation. These and other features, aspects, and advantages of the present invention will become better understood with regard to the following description, appended claims, and accompanying drawings.

### III. BRIEF DESCRIPTION OF THE DRAWINGS

FIG. 1 is a right perspective view of an embodiment of the adjustable display arm.

FIG. 2 is a right-side view of an embodiment of the adjustable display arm's arm assembly.

FIG. 3 is a right-side view of an embodiment of the adjustable display arm's arm assembly with the arm assembly's cover removed.

FIG. 4 is an exploded rear-perspective view of an embodiment of the arm assembly.

FIG. 5 is a front perspective view of an embodiment of the arm assembly's hinge mechanism.

FIG. 6 is a partial exploded view of an embodiment of the arm assembly's hinge mechanism.

FIG. 7 is an exploded view of an embodiment of the arm assembly's hinge mechanism.

FIG. 8 is a partial exploded view of an embodiment of the arm assembly's hinge mechanism.

FIG. 9 is a cross-sectional of an embodiment of the arm assembly's hinge mechanism showing the inner components.

FIG. 10 is an exploded view of an alternative embodiment of the arm assembly's hinge mechanism.

FIG. 11 is a cross-sectional of an alternative embodiment of the arm assembly's hinge mechanism showing the inner components.

FIG. 12 is a rear perspective view of an embodiment of the adjustable display arm's mount assembly.

FIG. 13 is an exploded view of an embodiment of the adjustable display arm's mount assembly.

FIG. 14 is a top view of an embodiment of the adjustable display arm's mount assembly.

FIG. 15 is a rear perspective view of an alternative embodiment of the adjustable display arm's mount assembly.

FIG. 16 is an exploded view of an alternative embodiment of the adjustable display arm's mount assembly.

FIG. 17 is a right-side view of an embodiment of the adjustable display arm's base assembly.

FIG. 18 is an exploded view of an embodiment of the adjustable display arm's base assembly.

### IV. DESCRIPTION

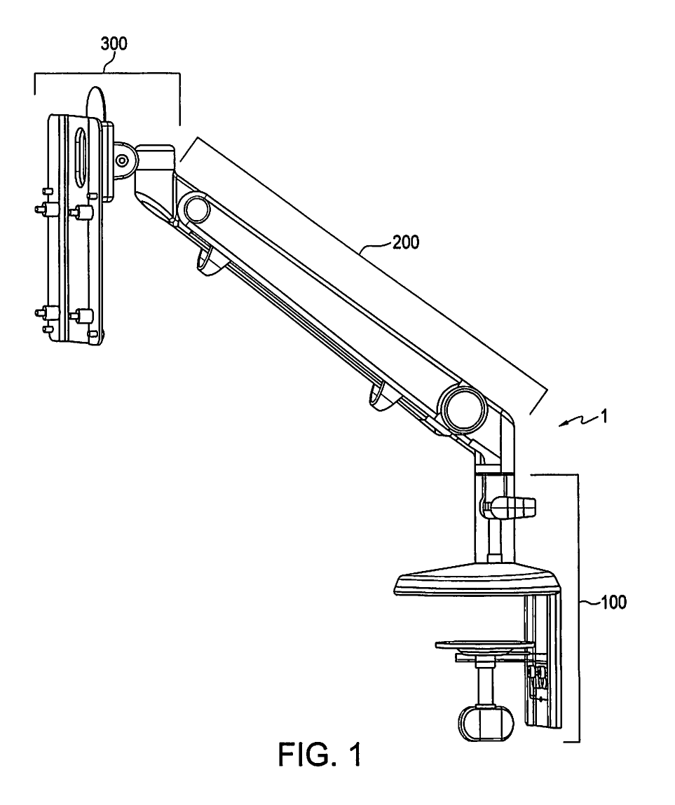

The adjustable display arm 1 described herein utilizes a single motion, friction-locking hinge mechanism to support the weight of an attached flat-panel display. Referring to FIG. 1, the adjustable display arm 1 comprises an arm assembly 200 interconnecting a mount assembly 300 and base assembly 100.

A. Embodiments of the Arm Assembly

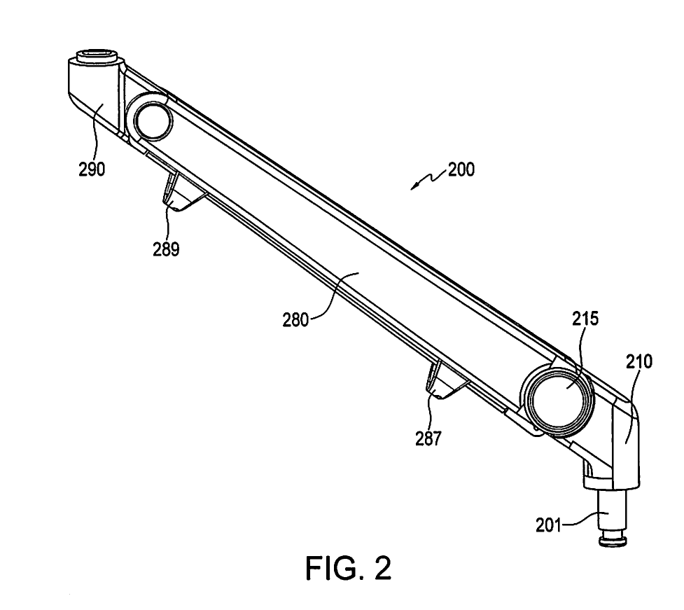

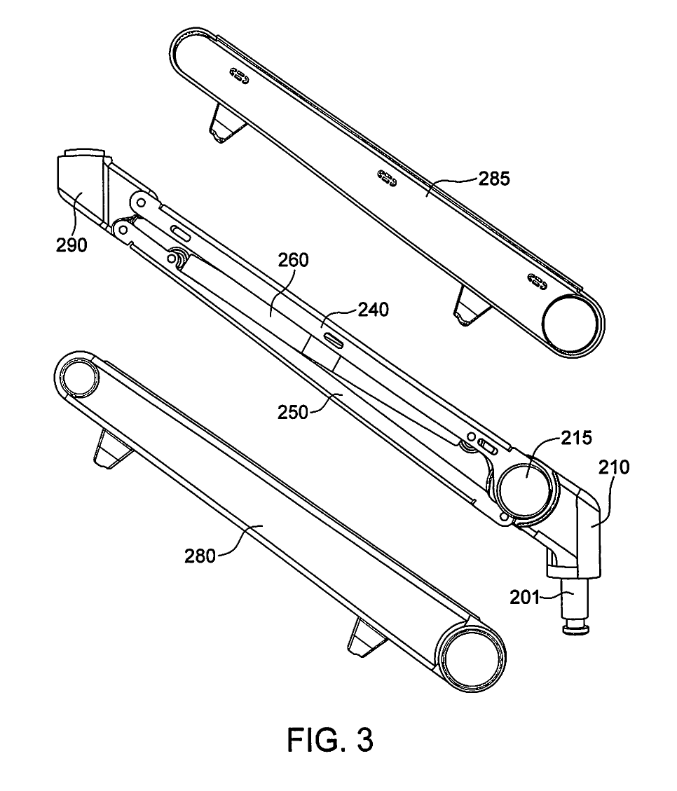

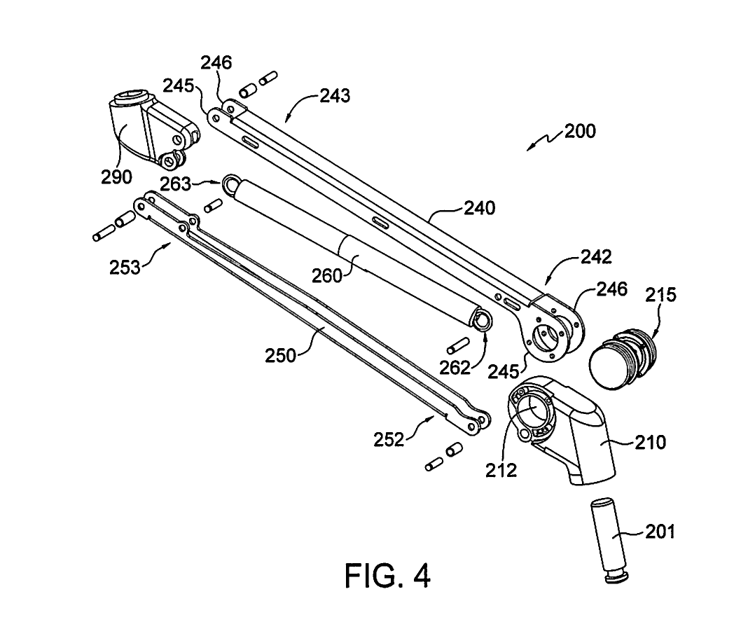

Referring to FIGS. 2-4, the arm assembly 200 can comprise a lower arm bracket 210, a hinge mechanism 215, an upper link 240, a lower link 250, and an upper arm bracket 290. The upper link 240 and lower link 250 form a parallel linkage. The hinge mechanism 215 connects the upper link's first end 242 to the lower arm bracket 210. The upper link's second end 243 is pivotally attached to the upper arm bracket 290. The lower link's first end 252 is pivotally attached to the lower arm bracket 210. The lower link's second end 253 is pivotally attached to the upper arm bracket 290. The arm assembly 200 can also comprise a right arm cover 280 and a left arm cover 285. The right and left arm covers 280, 285 can feature a first cable guide 287 and a second cable guide 289.

A spring 260 can be utilized to bias the arm assembly 200's vertical position. The spring's first end 262 can be attached to the upper link's first end 242, and the spring's second end 263 can be attached to the lower link's second end 253. In other embodiments, a gas cylinder may be substituted in place of the spring 260.

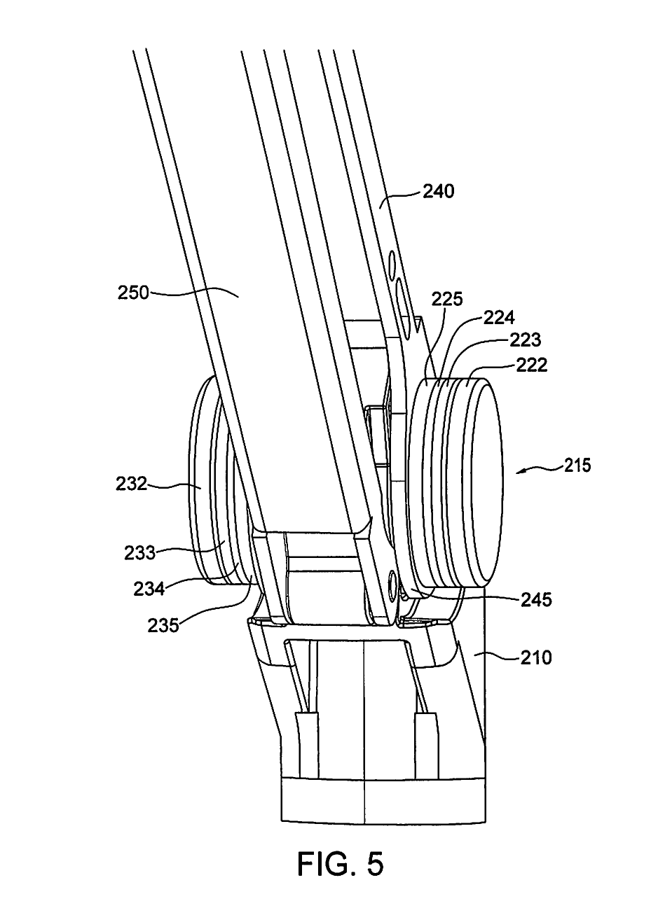

An embodiment of the hinge mechanism is depicted in FIGS. 5-9. The hinge mechanism 215 is mounted to the aperture 212 in the lower arm bracket 210. In the embodiment depicted in FIGS. 5-9, the hinge mechanism comprises a shaft 217, a clutch bearing 218, and a friction pack 220.

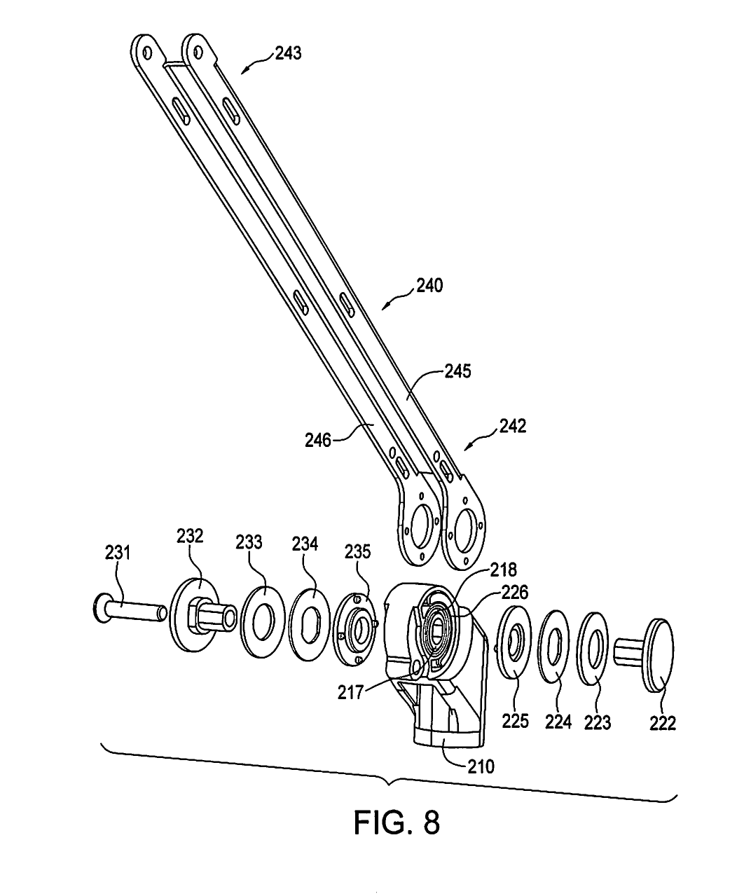

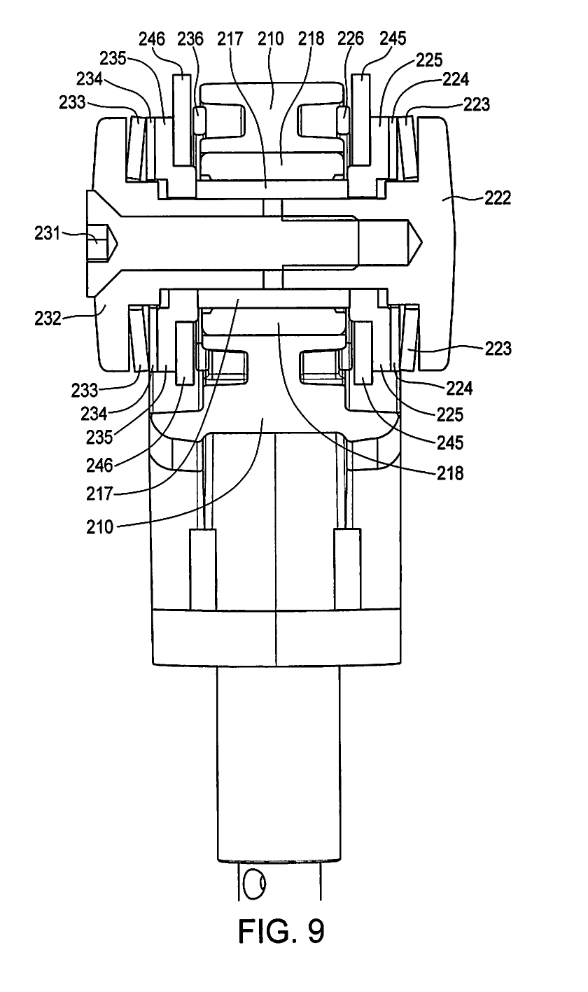

Referring to FIGS. 8-9, the clutch bearing 218 has an inner periphery mounted to the shaft 217 and an outer periphery fixedly attached to the lower arm bracket's aperture 212. The clutch bearing 218 can be a one-way clutch bearing which allows the shaft 217 to rotate freely (i.e., freewheel) in a first direction. However, the clutch bearing 218 will lock when rotated in the second direction, thereby preventing the shaft 217 from rotating in the second direction.

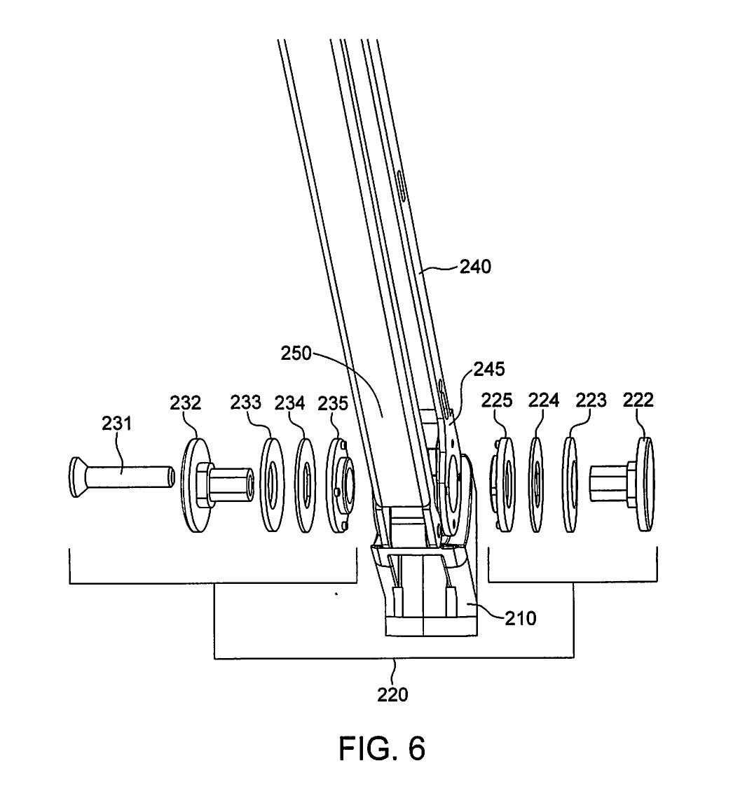

Referring to FIGS. 6-9, the friction pack 220 can comprise a first hinge cap 222, a second hinge cap 232, a first spring washer 223, a second spring washer 233, a first keyed washer 224, a second keyed washer 234, a first bushing 225, a second bushing 235, and a fastener 231.

Referring to FIGS. 6-9, both the first hinge cap 222 and second hinge cap 232 each have a head and a body. The heads of the first and second hinge caps 222, 232 are larger in diameter than the apertures in the first and second sides 245, 246, while the bodies of the first and second hinge caps 222, 232 are smaller in diameter than the apertures in the first and second sides 245, 246. The first hinge cap 222's body can feature a threaded hole or bore for receiving the fastener 231. The second hinge cap 232 can feature a countersink to allow the head of the fastener 231 to sit flush with the surface of the hinge cap 232. The fastener 231 can be a bolt, screw, or any other threaded fastener.

The first and second keyed washers 224, 234 can be mounted on the bodies of the first and second hinge caps 222, 232, respectively. As depicted in FIGS. 6-8, the first and second keyed washers 224, 234 can have special-shaped (i.e., non-circular) holes which fit over the corresponding special-shaped bodies of the first and second hinge caps 222, 232. In this arrangement, the first keyed washer 224 will not turn independently about the body of the first hinge cap 222, and the second keyed washer 234 will not turn independently about the body of the second hinge cap 232. In other words, first and second keyed washers 224, 234 will turn as the first and second hinge caps 222, 232 turn.

Referring again to FIGS. 6-9, the first spring washer 223 can be mounted on the body of the hinge cap 222 between the keyed washer 224 and the head of the hinge cap 222. Similarly, the second spring washer 233 can be mounted on the body of the hinge cap 232 between the keyed washer 234 and the head of the hinge cap 232. The first spring washer 223 provides a preload between the first keyed washer 224 and the head of the first hinge cap 222, while the second spring washer 233 provides a preload between the second keyed washer 234 and the head of the second hinge cap 232. This preload increases the ability of a user to tune the friction pack 220 to provide the desired resistance. Various types of spring washers can be used, including but not limited to Belleville washers, bowed or curved washers, dome washers, crescent washers, wave washers, extension springs, and compression springs.

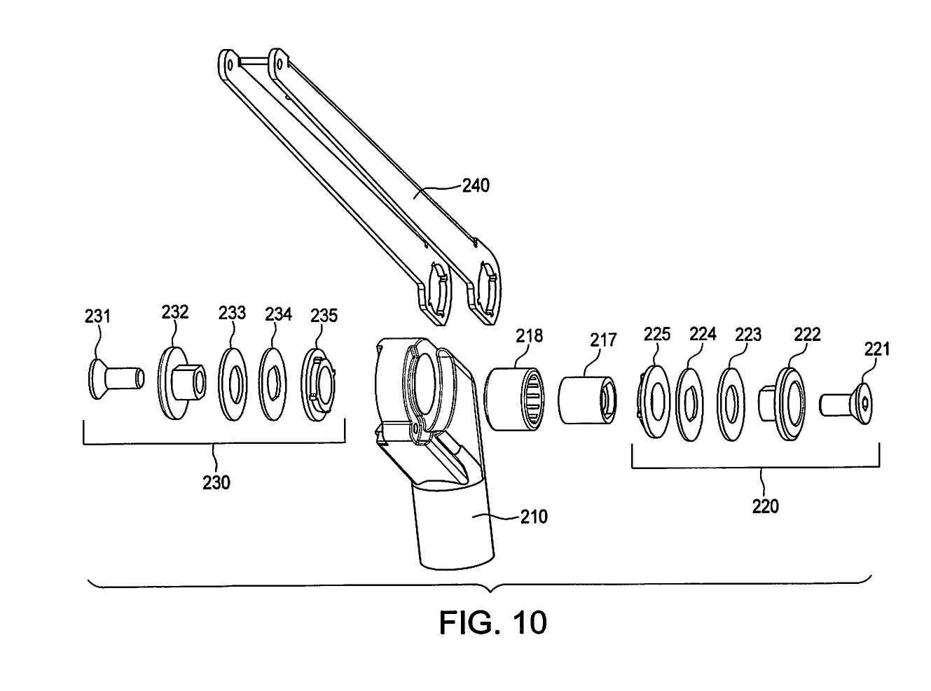

The first bushing 225 can be fixedly coupled to the upper link's first side 245, while the second bushing can be fixedly coupled to the upper link's second side 246. In the embodiment depicted in FIGS. 6-8, the first and second bushings 225, 235 have prongs which engage holes in the first and second sides 245, 246. In an alternative embodiment depicted in FIG. 10, the first and second bushings 225, 235 have notches which engage recesses in the apertures in the first and second sides 245, 246. In other embodiments, the first and second bushings 225, 235 can be secured to the first and second sides 245, 246 by welding, soldering, gluing, or any other known means in the art. Various types of bushings can be used, ranging from solid polymer bushings to oil impregnated self-lubricating bushings. (commonly referred to as Oilite bearings or bushings)

In the embodiment depicted in FIGS. 5-9, the shaft 217 is a hollow cylinder. The inner periphery of each end of the shaft 217 is notched, keyed, or otherwise non-circular. The first hinge cap 222 and second hinge cap 232 each have a corresponding notched, keyed, or non-circular outer periphery which engages the non-circular inner periphery of the shaft 217 at opposite ends. In this arrangement, both the first hinge cap 222 and the second hinge cap 232 will rotate as the shaft 217 rotates. In other embodiments, the first hinge cap 222 and second hinge cap 232 can be attached to the shaft 217 by bolts, pins, adhesives, or any other means known in the art.

The friction pack 220 functions to provide frictional resistance to the lowering of the arm assembly 200. When the friction pack 220 is assembled, the first keyed washer 224 will abut the first bushing 225 to provide a first bearing surface, and the second keyed washer 234 will abut the second bushing 235 to provide a second bearing surface. The first and second bushings 225, 235 will also abut opposite ends of the shaft 217 to provide third and fourth bearing surfaces. As depicted in FIG. 9, the fastener 231 extends successively through the second hinge cap 232, the second spring washer 233 (which is mounted on the second hinge cap 232), the second keyed washer 234 (which is also mounted on the second hinge cap 232), the second bushing 235, the aperture in the upper link's second side 246, the shaft 217, the aperture in the upper link's first side 245, the first bushing 225, the first keyed washer 224 (which is mounted on the first hinge cap 222), and the first spring washer 223 (which is also mounted on the first hinge cap 222) to engage the threaded hole in the first hinge cap 222. The fastener 231 provides a clamping force between the first, second, third, and fourth bearing surfaces. As the fastener 401 is tightened, the first and second keyed washers 224, 225 will be forced into contact with the first and second bushings 225, 235. The first and second bushings 225, 235 will also be forced in contact with opposite ends of the shaft 217. As the friction at the first, second, third, and fourth bearing surfaces increases, the resistance to the lowering of the arm assembly 200 increases.

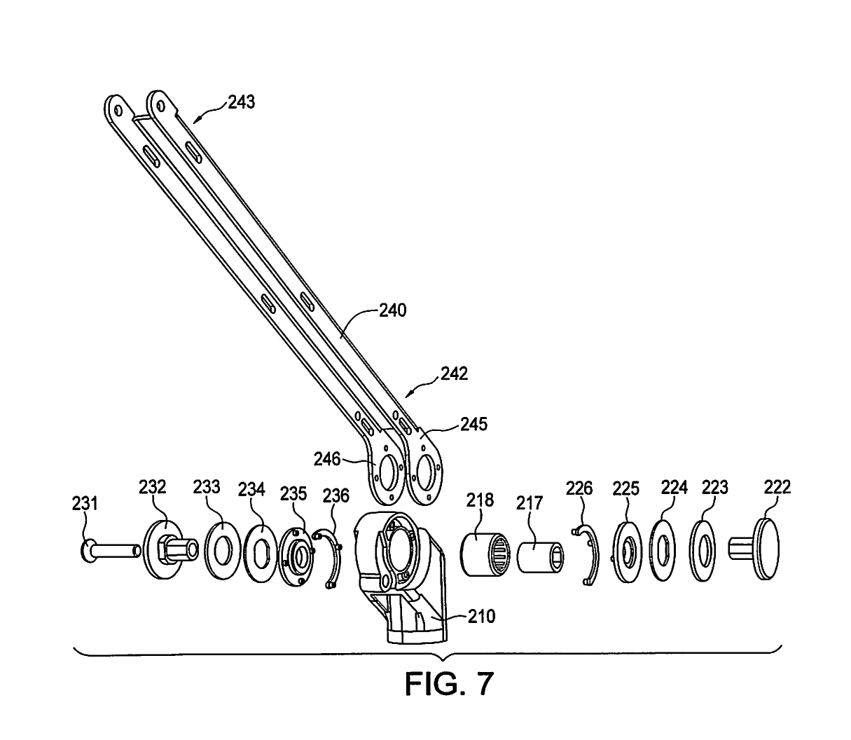

Referring to FIGS. 7-9, an embodiment of the hinge mechanism 215 can also feature a first spacer 226 and a second spacer 236. The first and second spacers 226, 227 function to protect the clutch bearing from being contacted by the upper link's first and second sides 245, 246. As shown in FIG. 8, the first spacer 226 is attached to one side of the lower arm bracket 210, and the second spacer 236 is attached to the opposite side of the lower arm bracket 210.

The arm assembly 200's single motion, friction-locking hinge mechanism operates as follows. As a user raises the arm assembly 200, the upper link 240 will pivot about the hinge assembly 215. The pivoting of the upper link 240 in an upward direction will cause the first and second bushings 225, 235—which are attached to the upper link 240—to rotate in the first direction. Because the first and second bushings 225, 235 are in frictional engagement with the first and second washers 224, 234 respectively, the rotation of the first and second bushings 225, 235 in the first direction will drive the first and second washers 224, 225 to rotate in the first direction, which in turn will drive the first and second hinge caps 222, 232 and the shaft 217 to rotate in the first direction. Because the clutch bearing 218 allows the shaft 217 to rotate freely (i.e., freewheel) in the first direction, the arm assembly 200 will provide minimal resistance to a user raising an attached flat-panel display.

The arm assembly's single motion, friction-locking hinge mechanism will provide resistance to the lowering of the arm assembly 200, thereby supporting the weight of an attached flat-panel display. The weight of the attached flat-panel display will exert a downward force, biasing the upper link 240 to pivot about the hinge assembly 215 in a downward direction. The pivoting of the upper link 240 in a downward direction will cause the first and second bushings 225, 235—which are attached to the upper link 240—to rotate in the second direction. Although the first and second bushings 225, 235 are in frictional engagement with the first and second washers 224, 234 respectively, the rotation of the first and second bushings 225, 235 in the second direction will not drive the first and second washers 224, 234 to rotate in the second direction. Rather, the first and second washers 224, 225 will be locked in position. The first and second washers 224, 225 will be locked in position because the clutch bearing 218 locks when rotated in the second direction, thereby preventing the shaft 217, the first and second hinge caps 222, 232, and all other components mounted thereto from rotating in the second direction. Because the fastener 231 is exerting a clamping force, friction will exist at the first, second, third, and fourth bearing surfaces. This friction, which can be adjusted by tightening or loosening the fastener 231, provides the resistance to the lowering of the arm assembly 200. When the fastener 231 is tightened to the appropriate tension, the arm assembly's single motion, friction-locking hinge mechanism effectively locks the attached flat-panel display in the desired position. The arm assembly 200 will remain at the desired height until the user applies a downward force to the arm assembly 200 sufficient to overcome the resistance provided by the hinge mechanism 215.

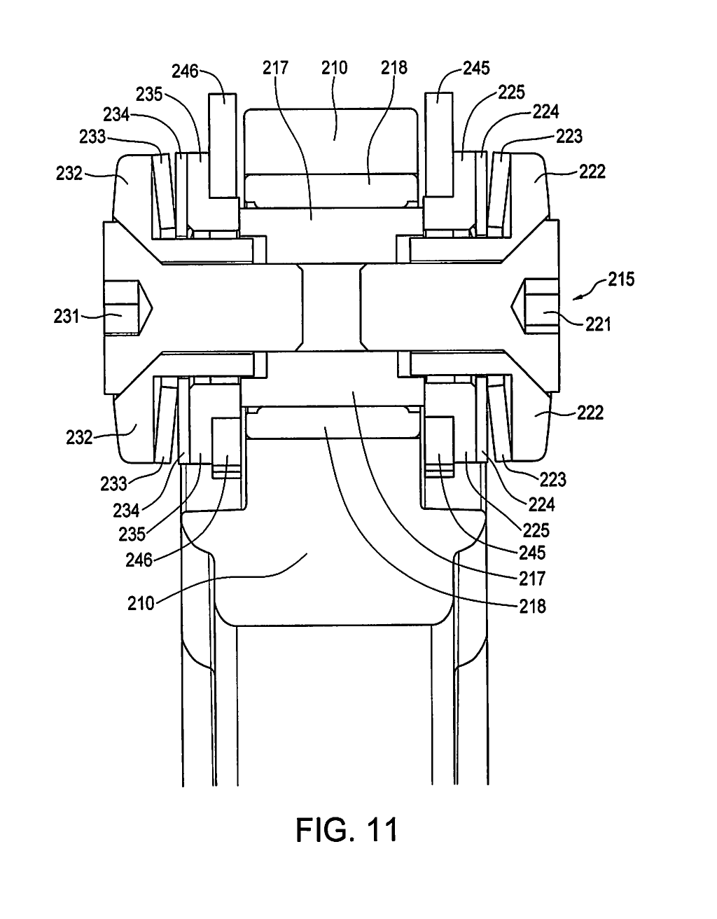

An alternative embodiment of the hinge mechanism 215 is shown in FIGS. 10-11. In this embodiment, the shaft 217 is not completely hollow. Rather, the middle of the shaft 217 is solid and has one or more threaded bores designed to receive one or more threaded fasteners. The inner periphery of the ends of the shaft 217 can remain notched, keyed, or otherwise non-circular and therefore can still be engaged by the non-circular outer peripheries of the first and second hinge caps 222, 232. Alternatively, the first hinge cap 222 and second hinge cap 232 can be attached to the shaft 217 by bolts, pins, adhesives, or any other means known in the art.

Still referring to the embodiment depicted in FIGS. 10-11, a first friction pack 220 can attach the upper link's first side 245 to the lower arm bracket 210, and a second friction pack 230 can attach the upper link's second side 246 to the lower arm bracket 210. The first friction pack 220 can comprise a first fastener 221, a first hinge cap 222, a first spring washer 223, a first keyed washer 224, and a first bushing 405. When assembled, the first fastener 221 extends through the first hinge cap 222 and the aperture in the upper link's first side 245 to engage a first threaded hole in the shaft 217. The second friction pack 230 can comprise a second fastener 231, a second hinge cap 232, a second spring washer 233, a second keyed washer 234, and a second bushing 235. When assembled, the second fastener 231 extends through the second hinge cap 232 and the aperture in the upper link's second side 246 to engage a second end of the threaded hole in the shaft 217 or a second threaded hole in the shaft 217.

While FIGS. 10-11 show both a first friction pack 220 and a second friction pack 230 being utilized, a single friction pack could be used in an alternative embodiment. Other alternative configurations of the friction pack(s) could include utilizing a fastener either separately or in combination with a hinge cap, a spring washer, a keyed washer, and/or a bushing. For instance, the hinge mechanism 215 could comprise a single friction pack, with the friction pack comprising a fastener extending through an aperture in the side of the upper link to engage a threaded hole in the shaft. In this embodiment, the head of the fastener would abut the outer periphery of the side of the upper link to form a bearing surface. As the fastener is tightened, the friction between the head of the fastener and the side of the upper link would increase to provide greater resistance to the lowering of the arm assembly. In another alternative embodiment, the friction pack could comprise a fastener extending through a hinge cap and an aperture in the side of the upper link to engage a threaded hole in the shaft. In this embodiment, the head of the hinge cap would abut the outer periphery of the side of the upper link to form the bearing surface. In yet another embodiment, the friction pack could comprise a fastener, a countersunk hinge cap, and a threaded hinge cap. The fastener would extend through the countersunk hinge cap and the shaft to engage the threaded hole in the threaded hinge cap. In another embodiment, the friction pack could comprise a fastener, a hinge cap, and a keyed washer. Alternatively, the friction pack could comprise a fastener, a hinge cap, and spring washer.

B. Embodiments of the Mount Assembly

The mount assembly 300 is designed to give a user the ability to tilt an attached flat-panel monitor both horizontally and vertically. The mount assembly 300 also utilizes a quick release feature, which allows the user to quickly detach the flat-panel monitor from the adjustable display arm 1 without any tools.

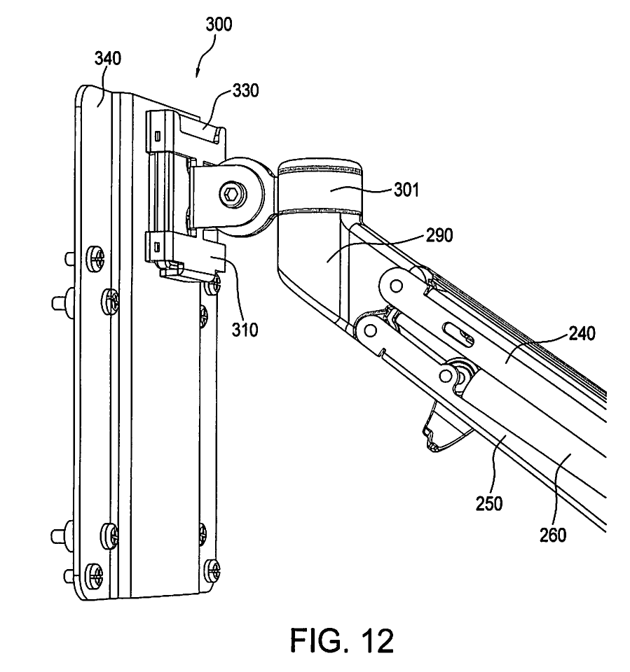

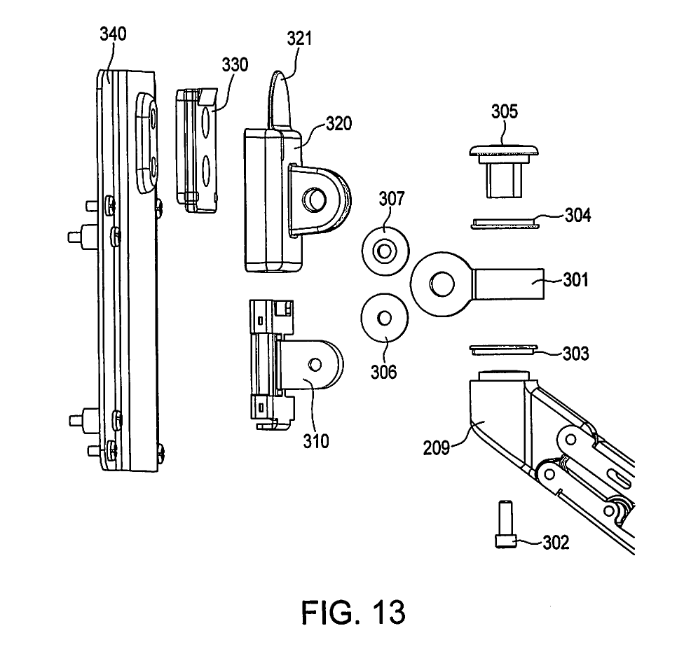

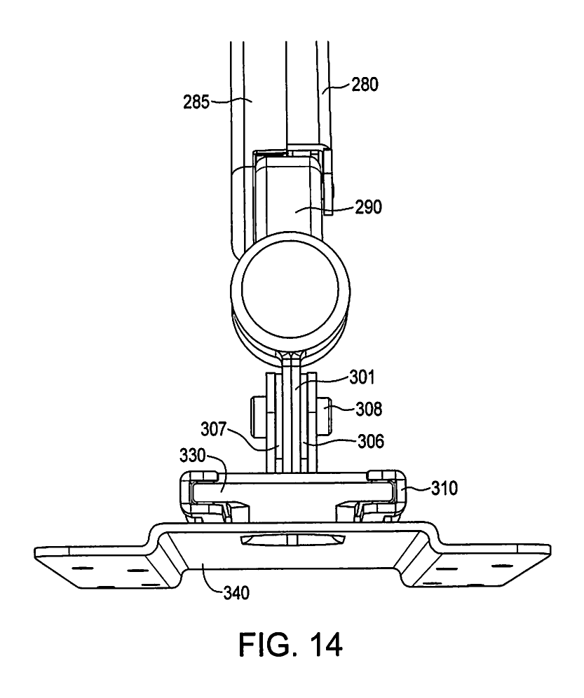

An embodiment of the mount assembly 300 is shown in FIGS. 12-14. The mount assembly 300 can comprise a pivot bracket 301, a mounting bracket 310, a tongue 330, and a mounting plate 340.

The pivot bracket 301 has a horizontal ring and a vertical ring. A pivot bracket cap 305 extends through the pivot bracket 301's horizontal ring to pivotally attach the pivot bracket 301 to the arm assembly's upper arm bracket 290. A fastener 302 engages the pivot bracket cap 305 to secure the pivot bracket 301 to the upper arm bracket 290. A lower bearing 303 and an upper bearing 304 can be used to facilitate the horizontal pivoting of the pivot bracket 301 with respect to the upper arm bracket 290.

The mounting bracket 310 is pivotally attached to the pivot bracket 301's vertical ring. A right bearing 306 and a left bearing 307 can be used to facilitate the vertical pivoting of the mounting bracket 310 with respect to the pivot bracket 301.

The mounting bracket 310 has a slot which accepts the tongue 330. Thus, when the tongue 330 is secured to the mounting plate 340, the mounting plate 340 and tongue 330 can slidably engage the mounting bracket 310. A flat-panel monitor or display device can be attached to the mounting plate 340 by bolts, screws, or any other conventional means.

A mounting bracket cover 320 can be attached to the mounting bracket 310. The mounting bracket cover 320 has a flexible quick release handle 321 which engages the top of the tongue 330 to lock the tongue 330 in engagement within the mounting bracket 310. A user can disengage the tongue 330 from the mounting bracket 310 by applying a force to the quick release handle 321.

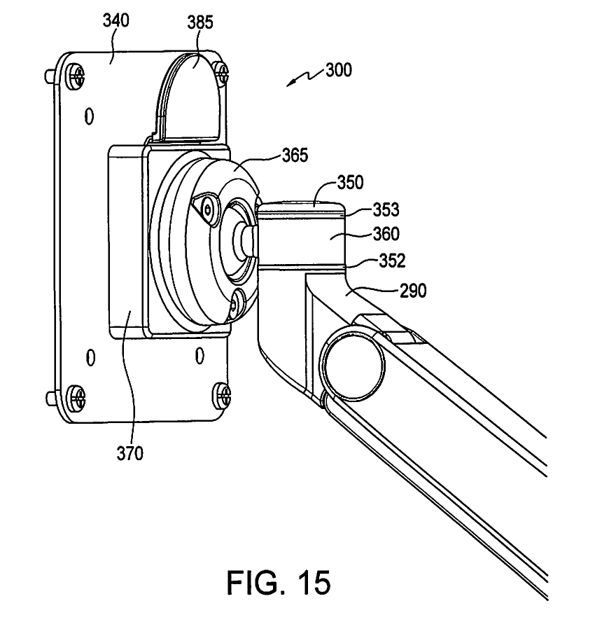

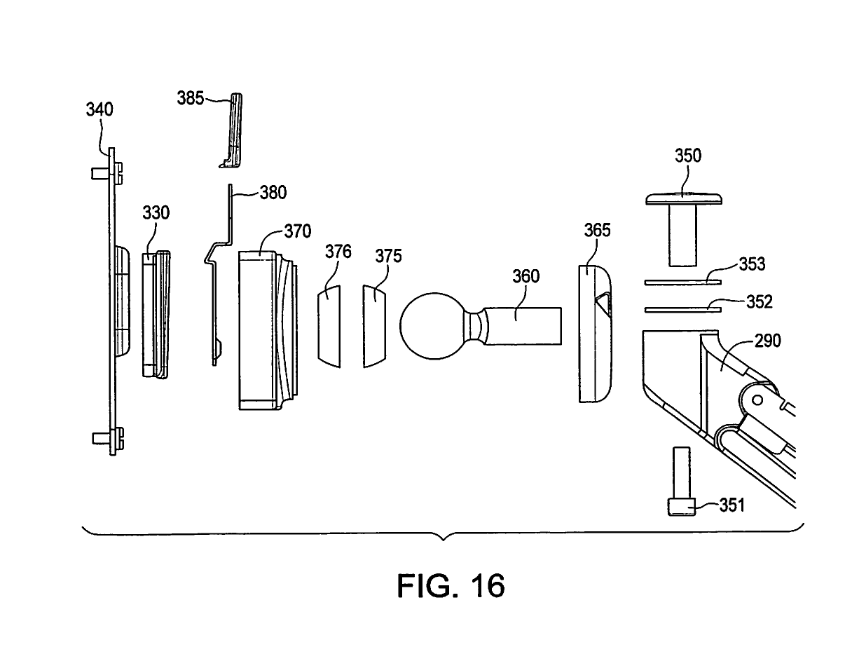

An alternative embodiment of the mount assembly 300 is depicted in FIGS. 15-16. The mount assembly 300 can comprise a ball joint bracket 360, a first ball joint case 365, a second ball joint case 370, a tongue 330, and a mounting plate 340.

The ball joint bracket 360 defines a horizontal ring attached to a ball component. A pivot bracket cap 350 extends through the ball joint bracket 360's horizontal ring to pivotally attach the ball joint bracket 360 to the arm assembly's upper arm bracket 290. A fastener 351 engages the pivot bracket cap 350 to secure the ball joint bracket 360 to the upper arm bracket 290. A lower bearing 352 and an upper bearing 353 can be used to facilitate the horizontal pivoting of the ball joint bracket 360 with respect to the upper arm bracket 290.

When assembled, the ball joint bracket 360's ball component is disposed between the first ball joint case 365 and the second ball joint case 370. The first ball joint case 365 can be attached to the second ball joint case 370 by fasteners, clamps, rivets, glue, or any other means known in the art. First and second ball joint cups 375, 376 can be disposed around the ball component to stabilize the ball component within the ball joint casing.

The second ball joint case 370 can also feature a slot which accepts the tongue 330. Thus, when the tongue 330 is secured to the mounting plate 340, the mounting plate 340 and tongue 330 can slidably engage the slot in the second ball joint case 370.

A quick release spring 380 can be attached to the second ball joint case 370 by fasteners, clamps, rivets, glue, or any other means known in the art. The quick release spring 380 engages the top of the tongue 330 to lock the tongue 330 in engagement within the second ball joint case 370's slot. A user can disengage the tongue 330 from the second ball joint case 370 by applying a force to the quick release spring 380. A quick release handle 385 can be attached to the quick release spring 380.

C. Embodiments of the Base Assembly

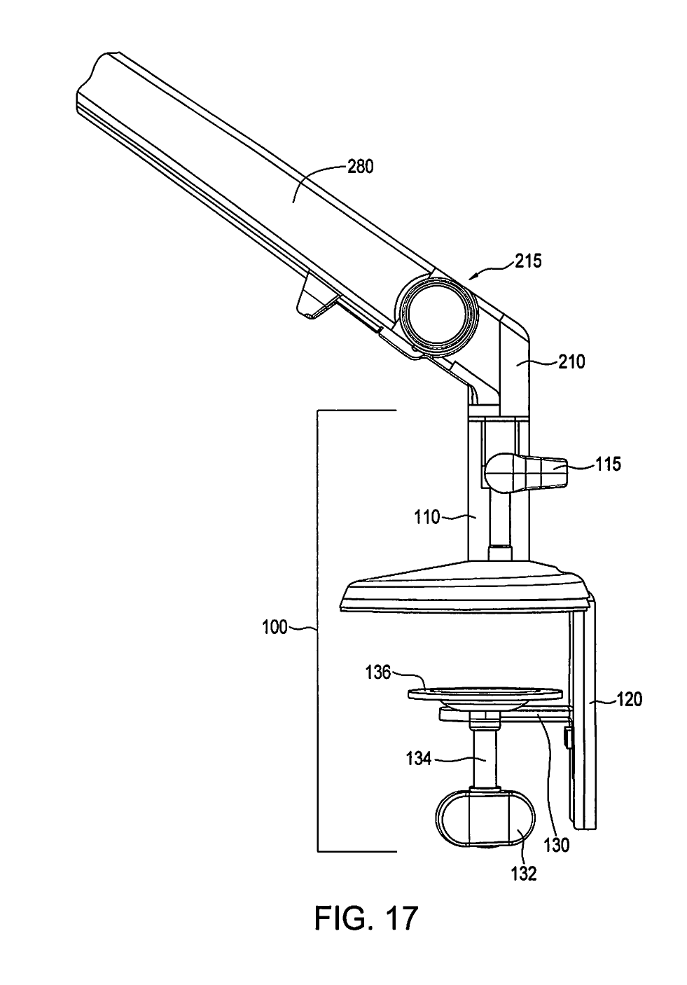

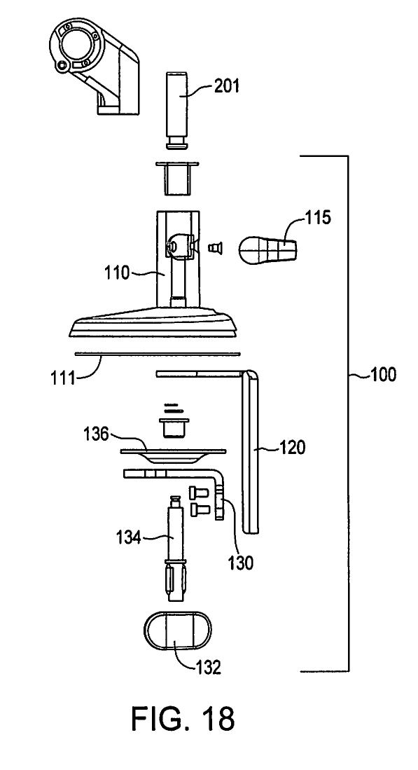

The base assembly 100 is designed to give a user the ability to secure the adjustable display arm 1 to a desk or table. An embodiment of the base assembly 100 is shown in FIGS. 17-18. The base assembly 100 can comprise a base 110, a first base bracket 120, and a second base bracket 130.

The upper end of the base 110 is attached to the lower arm bracket 210 by a connecter shaft 201, while the lower end of the base 110 is attached to the first base bracket 120 by fasteners, adhesives, or any means known in the art. The second base bracket 130 is attached to the first base bracket 120. The second base bracket 130 features a threaded aperture which is engaged by a threaded rod 134. A clamping plate 136 can be attached to the upper end of the threaded rod 134, while a knob 132 can be attached to the lower end. When assembled, the clamping plate 136 will be substantially parallel with the lower end of the base 110. The base 110 forms a first clamping surface, while the clamping plate 136 forms a second clamping surface. A user can secure the adjustable display arm 1 to a desk or table by positioning the desk surface between the first and second clamping surfaces. The knob 132 can then be rotated in a first direction to raise the clamping plate 136 into contact with the underside of the desk surface.

In other embodiments, the base assembly 100 can feature a base pad 111 positioned between the base 110 and the first base bracket 120. A third cable guide 115 can also be attached to the base 110.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An arm assembly comprising:
a. A lower arm bracket;
b. An upper link defining a first end and a second end;
c. A hinge mechanism connecting the upper link's first end to the lower arm bracket, the hinge mechanism comprising:
i. a shaft having a first end and a second end;
ii. a one-way clutch bearing having an inner periphery and an outer periphery, the inner periphery mounted to the shaft and the outer periphery mounted within an aperture in the lower arm bracket; and
iii. a friction pack attached to the shaft; and
d. An upper arm bracket attached to the upper link's second end.

2. The arm assembly of claim 1, wherein the upper link further defines a first side having an aperture and a second side having an aperture.

3. The arm assembly of claim 2, wherein the friction pack comprises:
a. A first hinge cap having a head and a body, the body of the first hinge cap extending through the aperture in the upper link's first side and attaching to the shaft's first end such that the first hinge cap rotates as the shaft rotates;
b. A second hinge cap having a head and a body, the body of the second hinge cap extending through the aperture in the upper link's second side and attaching to the shaft's second end such that the second hinge cap rotates as the shaft rotates; and
c. A threaded fastener extending through the second hinge cap and the shaft to engage a threaded bore in the first hinge cap.

4. The arm assembly of claim 3, wherein the friction pack further comprises a first bushing attached to the upper link's first side.

5. The arm assembly of claim 4, wherein the friction pack further comprises a first keyed washer mounted on the body of the first hinge cap.

6. The arm assembly of claim 5, wherein the friction pack further comprises a first spring washer mounted on the body of the first hinge cap and positioned between the first keyed washer and the head of the first hinge cap.

7. The arm assembly of claim 3, wherein the friction pack further comprises:
a. A first bushing attached to the upper link's first side; and
b. A second bushing attached to the upper link's second side.

8. The arm assembly of claim 7, wherein the friction pack further comprises:
a. A first keyed washer mounted on the body of the first hinge cap; and
b. A second keyed washer mounted on the body of the second hinge cap.

9. The arm assembly of claim 8, wherein the friction pack further comprises:
a. A first spring washer mounted on the body of the first hinge cap and positioned between the first keyed washer and the head of the first hinge cap; and
b. A second spring washer mounted on the body of the second hinge cap and positioned between the second keyed washer and the head of the second hinge cap.

10. The arm assembly of claim 9, further comprising a first spacer and a second spacer, wherein the first spacer is attached to a first side of the lower arm bracket such that the first spacer is positioned between the lower arm bracket and the upper link's first side, and wherein the second spacer is attached to a second side of the lower arm bracket such that the second spacer is positioned between the lower arm bracket and the upper link' second side.

11. The arm assembly of claim 9, further comprising a lower link having a first end and a second end, the first end attached to the lower arm bracket, the second end attached to the upper arm bracket.

12. The arm assembly of claim 11, further comprising a spring having a first end and a second end, the first end of the spring attached to the first end of the upper link, the second end of the spring attached to the second end of the lower link.

13. The arm assembly of claim 3, wherein the first hinge cap frictionally engages the upper link's first side to define a first bearing surface, and wherein the second hinge cap frictionally engages the upper link's second side to define a second bearing surface.

14. The arm assembly of claim 7, wherein the first hinge cap frictionally engages the first bushing to define a first bearing surface, and wherein the second hinge cap frictionally engages the second bushing to define a second bearing surface.

15. The arm assembly of claim 7, wherein the first hinge cap frictionally engages the first bushing to define a first bearing surface, the second hinge cap frictionally engages the second bushing to define a second bearing surface, the first bushing frictionally engages the shaft's first end to define a third bearing surface, and the second bushing frictionally engages the shaft's second end to define a fourth bearing surface.

16. The arm assembly of claim 8, wherein the first hinge cap frictionally engages the first bushing to define a first bearing surface, the second hinge cap frictionally engages the second bushing to define a second bearing surface, the first bushing frictionally engages the shaft's first end to define a third bearing surface, and the second bushing frictionally engages the shaft's second end to define a fourth bearing surface.

17. The arm assembly of claim 9, wherein the first hinge cap frictionally engages the first bushing to define a first bearing surface, the second hinge cap frictionally engages the second bushing to define a second bearing surface, the first bushing frictionally engages the shaft's first end to define a third bearing surface, and the second bushing frictionally engages the shaft's second end to define a fourth bearing surface.

18. The arm assembly of claim 1, wherein the upper link further defines a first side having an aperture.

19. The arm assembly of claim 18, wherein the friction pack comprises a fastener having a head and a body, wherein the body of the fastener extends through the aperture in the upper link's first side to engage a threaded bore in the shaft.

20. The arm assembly of claim 18, wherein the friction pack comprises:
a. a hinge cap having a head and a body, the body of the hinge cap extending through the aperture in the upper link's first side and attaching to the shaft's first end such that the hinge cap rotates as the shaft rotates; and
b. A threaded fastener extending through the hinge cap to engage a threaded bore in the shaft.

21. The arm assembly of claim 20, wherein the friction pack further comprises a bushing attached to the upper link's first side.

22. The arm assembly of claim 20, wherein the friction pack further comprises:
a. a keyed washer mounted on the body of the hinge cap; and
b. a bushing attached to the upper link's first side.

23. The arm assembly of claim 20, wherein the friction pack further comprises:
a. a keyed washer mounted on the body of the hinge cap;
b. a spring washer mounted on the body of the hinge cap and positioned between the keyed washer and the head of the hinge cap; and
c. a bushing attached to the upper link's first side.

24. The arm assembly of claim 23, further comprising a spacer attached to the lower arm bracket such that the spacer is positioned between the lower arm bracket and the upper link.

25. The arm assembly of claim 23, further comprising a lower link defining a first end and a second end, the first end attached to the lower arm bracket, the second end attached to the upper arm bracket.

26. The arm assembly of claim 25, further comprising a spring having a first end and a second end, the first end of the spring attached to the first end of the upper link, the second end of the spring attached to the second end of the lower link.

27. The arm assembly of claim 20, wherein the hinge mechanism further comprises a second friction pack, the second friction pack comprising:
i. a second hinge cap having a head and a body, the body of the second hinge cap extending through an aperture in a second side of the upper link and attaching to the shaft's second end such that the second hinge cap rotates as the shaft rotates; and
ii. A second threaded fastener extending through the second hinge cap to engage a second threaded bore in the shaft.

28. The arm assembly of claim 21, wherein the hinge mechanism further comprises a second friction pack, the second friction pack comprising:
i. a second hinge cap having a head and a body, the body of the second hinge cap extending through an aperture in a second side of the upper link and attaching to the shaft's second end such that the second hinge cap rotates as the shaft rotates;
ii. a second bushing attached to the upper link's second side; and
iii. A second threaded fastener extending through the second hinge cap to engage a second threaded bore in the shaft.

29. The arm assembly of claim 22, wherein the hinge mechanism further comprises a second friction pack, the second friction pack comprising:
i. a second hinge cap having a head and a body, the body of the second hinge cap extending through an aperture in a second side of the upper link and attaching to the shaft's second end such that the second hinge cap rotates as the shaft rotates;
ii. a second keyed washer mounted on the body of the second hinge cap;
iii. a second bushing attached to the upper link's second side; and
iv. A second threaded fastener extending through the second hinge cap to engage a second threaded bore in the shaft.

30. The arm assembly of claim 23, wherein the hinge mechanism further comprises a second friction pack, the second friction pack comprising:
i. a second hinge cap having a head and a body, the body of the second hinge cap extending through an aperture in a second side of the upper link and attaching to the shaft's second end such that the second hinge cap rotates as the shaft rotates;
ii. a second keyed washer mounted on the body of the second hinge cap;
iii. a second spring washer mounted on the body of the second hinge cap and positioned between the second keyed washer and the head of the second hinge cap;
iv. a second bushing attached to the upper link's second side; and
v. A second threaded fastener extending through the second hinge cap to engage a second threaded bore in the shaft.

31. The arm assembly of claim 30, further comprising a first spacer and a second spacer, wherein the first spacer is attached to a first side of the lower arm bracket such that the first spacer is positioned between the lower arm bracket and the upper link's first side, wherein the second spacer is attached to a second side of the lower arm bracket such that the second spacer is positioned between the lower arm bracket and the upper link' second side.

32. The arm assembly of claim 30, further comprising a lower link defining a first end and a second end, the first end attached to the lower arm bracket, the second end attached to the upper arm bracket.

33. The arm assembly of claim 32, further comprising a spring having a first end and a second end, the first end of the spring attached to the first end of the upper link, the second end of the spring attached to the second end of the lower link.

34. An adjustable display arm, comprising:
a. A base assembly;
b. An arm assembly, the arm assembly comprising:
i. A lower arm bracket attached to the base assembly, the lower arm bracket having an aperture;
ii. An upper link defining a first end, a second end, a first side having an aperture, and a second side having an aperture;
iii. A lower link defining a first end and a second end, the first end attached to the lower arm bracket;
iv. A hinge mechanism connecting the upper link's first end to the lower arm bracket, the hinge mechanism comprising:
1. a shaft;
2. a clutch bearing having an inner periphery and an outer periphery, the inner periphery mounted to the shaft and the outer periphery mounted within the aperture in the lower arm bracket; and
a. a friction pack attached to the shaft; and
v. An upper arm bracket attached to the upper link's second end and the lower link's second end; and
c. A mount assembly.

35. The adjustable display arm of claim 34, wherein the mount assembly comprises a pivot bracket attached to the upper arm bracket.

36. The adjustable display arm of claim 35, wherein the mount assembly further comprises a mounting bracket attached to the pivot bracket.

37. The adjustable display arm of claim 34, wherein the mount assembly comprises:
a. A pivot bracket attached to the upper arm bracket;
b. A mounting bracket attached to the pivot bracket;
c. A tongue slidably engaged with the mounting bracket; and
d. A mounting plate attached to the tongue.

38. The adjustable display arm of claim 37, wherein the mount assembly further comprises a means for releasably locking the tongue into engagement with the mounting bracket.

39. The adjustable display arm of claim 34, wherein the base assembly comprises a base.

40. The adjustable display arm of claim 34, wherein the base assembly comprises:
a. A base;
b. A first base bracket attached to the base;
c. A second base bracket attached to the first base bracket, the second base bracket having an internally threaded bore;
d. A threaded rod having a first end and a second end, the threaded rod engaging the second base bracket's internally threaded bore,
e. A knob attached to the threaded rod's first end; and
f. A clamping member attached to the threaded rod's second end.
